(19) United States
(12) Patent Application Publication
(10) Pub. No.: US 2025/0156885 A1
(43) Pub. Date: May 15, 2025

(54) COMPUTER-READABLE RECORDING MEDIUM STORING INFORMATION PROCESSING PROGRAM, INFORMATION PROCESSING METHOD, AND INFORMATION PROCESSING DEVICE

(71) Applicant: Fujitsu Limited, Kawasaki-shi (JP)

(72) Inventors: Shohei YAMANE, Kawasaki (JP); Yusuke OISHI, Yokohama (JP)

(73) Assignee: Fujitsu Limited, Kawasaki-shi (JP)

(21) Appl. No.: 18/938,317

(22) Filed: Nov. 6, 2024

(30) Foreign Application Priority Data
Nov. 9, 2023 (JP) 2023-191421

(51) Int. Cl. G06Q 30/0201

(52) U.S. Cl. CPC G06Q 30/0201

(57) ABSTRACT

A non-transitory computer-readable recording medium storing an information processing program for causing a computer to execute processing includes acquiring first information that includes information related to arrangement of a plurality of products in a store, acquiring second information that includes information that specifies one or a plurality of the products purchased by each of a plurality of customers, determining an estimation region in which each of the plurality of customers is estimated to have moved in the store based on the first information and the second information, and calculating an evaluation value for evaluation of how much the product is considered to have come into sight of the plurality of customers based on the first information and the estimation region.

### CROSS-REFERENCE TO RELATED APPLICATION

This application is based upon and claims the benefit of priority of the prior Japanese Patent Application No. 2023-191421, filed on Nov. 9, 2023, the entire contents of which are incorporated herein by reference.

### FIELD

The embodiment discussed herein is related to an information processing program, an information processing method, and an information processing device.

### BACKGROUND

In a case where a product displayed in a store easily comes into sight of a customer in the store, the customer may be more likely to purchase the product. In order to promote sales of products in a store, there is a demand for grasping how much a customer visually observes each product displayed in the store. As one of technologies for this demand, there is a technology of simulating a line of sight of a customer and evaluating how much a product is visually observed by the customer.

Japanese Laid-open Patent Publication No. 2021-47660, International Publication Pamphlet No. WO 2015/033577, U.S. Patent Application Publication No. 2015/0310447, and U.S. Patent Application Publication No. 2006/0200378 are disclosed as related arts.

### SUMMARY

According to an aspect of the embodiments, a non-transitory computer-readable recording medium storing an information processing program for causing a computer to execute processing includes acquiring first information that includes information related to arrangement of a plurality of products in a store, acquiring second information that includes information that specifies one or a plurality of the products purchased by each of a plurality of customers, determining an estimation region in which each of the plurality of customers is estimated to have moved in the store based on the first information and the second information, and calculating an evaluation value for evaluation of how much the product is considered to have come into sight of the plurality of customers based on the first information and the estimation region.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram exemplifying a configuration of an information processing device;

FIG. 2 is a diagram for describing an example of store information;

FIG. 3 is a diagram illustrating an example of a product category master;

FIG. 4 is a diagram illustrating an example of a product arrangement master;

FIG. 5 is a diagram illustrating an example of a product category arrangement master;

FIG. 6 is a diagram illustrating an example of a customer information master;

FIG. 7 is a diagram for describing an example of an estimation region;

FIG. 8 is a diagram exemplifying a movement trajectory of a customer;

FIG. 9 is a diagram illustrating a first specific example of the estimation region;

FIG. 10 is a diagram illustrating a second specific example of the estimation region;

FIGS. 11A and 11B are diagrams illustrating a third specific example of the estimation region;

FIG. 12 is a diagram illustrating a fourth specific example of the estimation region;

FIG. 13 is a diagram illustrating a first specific example of weighting;

FIG. 14 is a diagram for describing an example of a weighting calculation method;

FIG. 15 is a diagram illustrating a second specific example of the weighting;

FIG. 16 is a diagram illustrating a specific example of an evaluation value;

FIG. 17 is a diagram illustrating a flowchart exemplifying a procedure of information processing;

FIG. 18 is a diagram illustrating a flowchart exemplifying details of the procedure of the information processing; and

FIG. 19 is a diagram illustrating an example of a hardware configuration of the information processing device.

### DESCRIPTION OF EMBODIMENTS

In the prior art, equipment and a technology for acquiring a movement trajectory of a customer are needed, and it is difficult to implement simulation of a line of sight of the customer. Therefore, there is a problem that it is not easy to evaluate how much a product has come into sight of the customer.

According to one aspect, an object is to provide a technology capable of easily evaluating how much a product has come into sight of a customer.

Hereinafter, an information processing program, an information processing method, and an information processing device according to an embodiment will be described with reference to the drawings. Note that the embodiment does not limit the disclosed technology. Additionally, the individual embodiments may be appropriately combined with each other within a range that does not cause contradiction between processing contents.

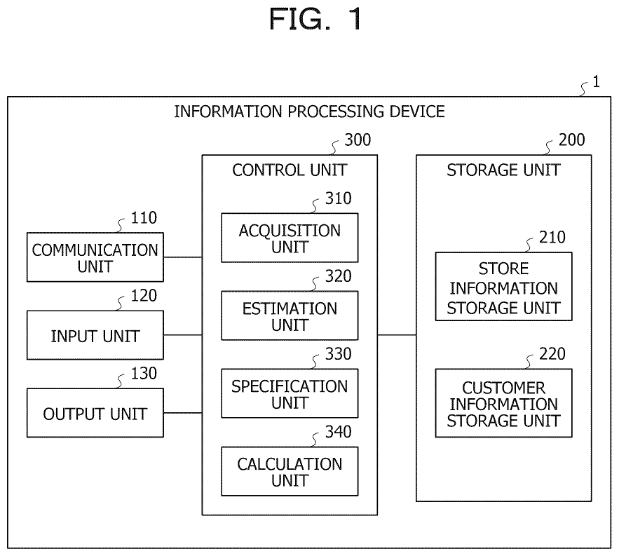

FIG. 1 is a functional block diagram exemplifying a configuration of the information processing device according to the present embodiment. As illustrated in FIG. 1, an information processing device 1 includes a communication unit 110, an input unit 120, an output unit 130, a storage unit 200, and a control unit 300.

The communication unit 110 is a processing unit that executes data communication with an external device (not illustrated) via a network. The communication unit 110 is an example of a communication device. The information processing device 1 may acquire store information and customer information to be described later from the external device. For example, point of sales (POS) data may be received from a POS device.

The input unit 120 is an input device for inputting various types of information to the information processing device 1. A user may operate the input unit 120 to input the store information and the customer information to be described later.

The output unit 130 is an output device that displays information output from the control unit 300.

The storage unit 200 is a functional unit that stores various types of information that are acquired, referred to, and the like in the information processing device 1, including an operating system (OS) executed by the control unit 300. The storage unit 200 includes a store information storage unit 210 and a customer information storage unit 220.

The store information storage unit 210 stores the store information. The store information is information related to a layout in a store. The store information includes information related to arrangement of a plurality of products displayed in the store. Note that the information related to the arrangement of the products may be information related to arrangement of each product, may be information related to sections for the respective product categories to which the plurality of products belongs, or may include both. Furthermore, the store information may include information related to arrangement of one or a plurality of entrances in the store, or may include information related to arrangement of one or a plurality of cash registers in the store. Examples of master data of the store information include a product category master 211, a product arrangement master 212, a product category arrangement master 213, and the like to be described later. Hereinafter, it is assumed that the product and the product category may be referred to as a product.

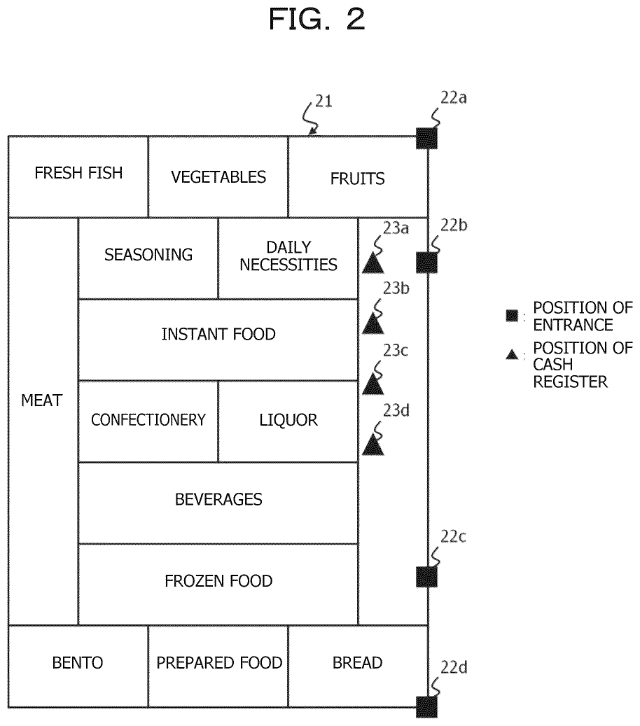

FIG. 2 is a diagram for describing an example of the store information. In FIG. 2, as an example, a layout 21 of product categories of products arranged in a supermarket is illustrated. Furthermore, in FIG. 2, as an example, a layout of entrances and cash registers arranged in the supermarket is illustrated.

In FIG. 2, fresh fish, vegetables, fruits, meat, and the like are exemplified as the product categories, but types, the number, and arrangement of the product categories, a range of types of products included in the product categories, and the like are not limited to these. In FIG. 2, positions of a first entrance 22a, a second entrance 22b, a third entrance 22c, and a fourth entrance 22d are exemplified as the entrances of the store. Furthermore, in FIG. 2, positions of a first cash register 23a, a second cash register 23b, a third cash register 23c, and a fourth cash register 23d are exemplified as the cash registers. The number, the arrangement, and the like of the entrances and the cash registers are not limited to the example of FIG. 2.

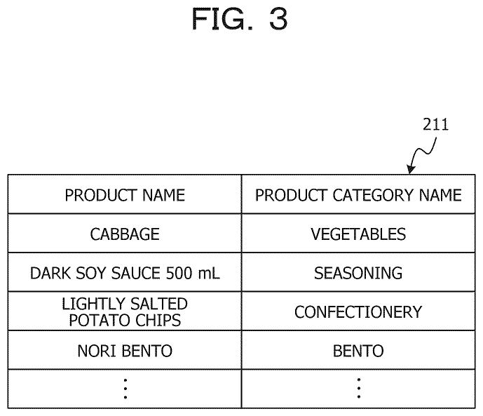

FIG. 3 is a diagram illustrating an example of the product category master. In the product category master 211, a correspondence relationship between a product in the store and a product category is defined. One or a plurality of products is included for one product category. In FIG. 3, as an example only, four sets of one product and a product category corresponding to the one product are excerpted and illustrated, but the products and the product categories may not be limited to the illustrated example.

In the example of the product category master 211 illustrated in FIG. 3, a product name “cabbage” and a product category name “vegetables” are associated with each other. For example, the product name “cabbage” is included in the product category of the product category name “vegetables”. Since the same applies to other product names and product category names illustrated in FIG. 3, the description thereof will be omitted.

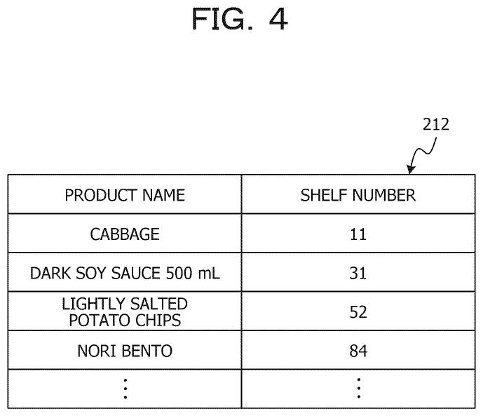

FIG. 4 is a diagram illustrating an example of the product arrangement master. In the product arrangement master 212, a correspondence relationship between a product in the store and a shelf number in which the product is arranged is defined. One or a plurality of shelf numbers is associated with one or a plurality of product names. In FIG. 4, as an example only, four sets of one product and a shelf in which the one product is displayed (not illustrated) are excerpted and illustrated, but the products and the shelf numbers may not be limited to the illustrated example. Furthermore, optional information may be used instead of the shelf number as long as the information is related to the arrangement of the product.

In the example of the product arrangement master 212 illustrated in FIG. 4, the product name “cabbage” and a shelf number “11” are associated with each other. Since the same applies to other product names and shelf numbers illustrated in FIG. 4, the description thereof will be omitted.

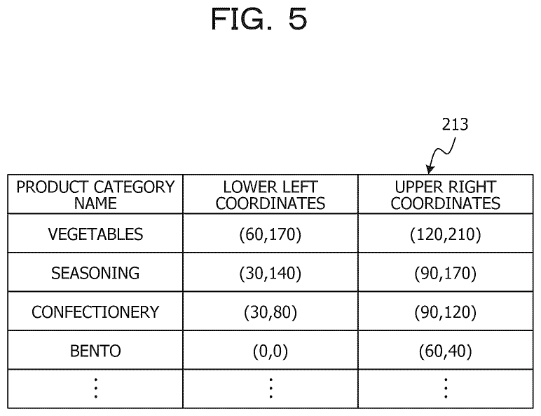

FIG. 5 is a diagram illustrating an example of the product category arrangement master. In the product category arrangement master 213, a correspondence relationship between a product category and arrangement of the product category is defined. In FIG. 5, as an example only, lower left coordinates and upper right coordinates are excerpted and illustrated as coordinate information of a rectangular region in which each of four product categories exists, but the coordinate information is not limited to the illustrated example. Note that the lower left coordinates and the upper right coordinates in FIG. 5 may correspond to lower left coordinates and upper right coordinates of a rectangular region of each product category in FIG. 2.

In the example of the product category arrangement master 213 illustrated in FIG. 5, the product category “vegetables” is associated with a rectangular region represented by lower left coordinates (60, 170) and upper right coordinates (120, 210). Since the same applies to other product category names and lower left coordinates and upper right coordinates illustrated in FIG. 5, the description thereof will be omitted.

Note that the coordinate information of the product category is not limited to the example of the lower left coordinates and the upper right coordinates, and expression of the coordinate information may be appropriately changed as long as a region of the product category may be specified.

Note that, although not exemplified in the drawing, the master data of the store information may include coordinate information related to the positions of the entrances and the cash registers in the store.

As an example, the product category master 211 illustrated in FIG. 3, the product arrangement master 212 illustrated in FIG. 4, and the product category arrangement master 213 illustrated in FIG. 5 are stored in the store information storage unit 210.

The customer information storage unit 220 stores the customer information. The customer information is information related to a customer who has shopped at the store. The customer information includes information specifying one or a plurality of products purchased by each of a plurality of customers. Furthermore, the customer information may include information related to a cash register that has been used by each of the plurality of customers, or may include information related to an entrance through which each of the plurality of customers has actually passed or is estimated to have passed. Moreover, the customer information may include purchase order of a plurality of products purchased by a customer for each of the plurality of customers.

Note that actual measurement data of the information related to the purchase order may be acquired by scanning the purchased products from a shopping cart integrated with a device having a POS function or a device such as a smartphone owned by the customer.

On the other hand, the information related to the purchase order may be estimated from the information related to the entrance through which the customer has passed or the cash register at which the customer has made a payment, without acquiring the actual measurement data. For example, it may be estimated that the products have been purchased in order from a product closer to the position of the entrance through which the customer has passed. Furthermore, it may be estimated that the products have been purchased in order from a product far from the position of the cash register at which the customer has made a payment.

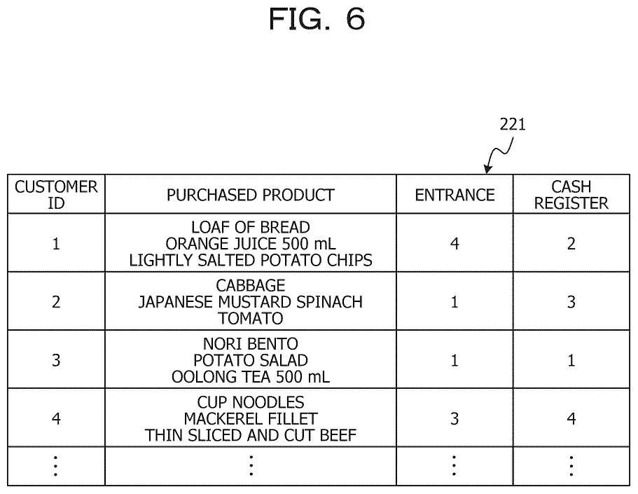

FIG. 6 is a diagram illustrating an example of a customer information master as an example of the customer information. In a customer information master 221, information related to a purchased product purchased by a customer, an entrance through which the customer has actually passed or is estimated to have passed when the customer has entered the store, and a cash register at which the customer has made a payment for the purchased product is associated with each customer identifier (ID) for identifying the customer. Note that the entrance through which the customer is estimated to have passed may not be associated with the customer ID for identifying the customer. In FIG. 6, as an example only, four pieces of the information related to the purchased product, the entrance, and the cash register associated with the customer ID are excerpted and illustrated, but the customer information is not limited to the example of FIG. 6.

In the example of the customer information master 221 illustrated in FIG. 6, it is indicated that a customer with a customer ID “1” has purchased “loaf of bread”, “orange juice 500 ml”, and “lightly salted potato chips”, has passed through an entrance “4”, and has made a payment at a cash register “2”. For example, information indicating purchase order indicating that the customer with the customer ID “1” has purchased “loaf of bread”, “orange juice 500 ml”, and “lightly salted potato chips” in this order may be included.

As an example, the information related to the purchased product purchased by the customer and the information related to the cash register at which the customer has made a payment for the purchased product are obtained from POS information. The POS information is obtained by, for example, scanning the purchased product from a cash register having the POS function, a shopping cart integrated with a device having the POS function, and a device such as a smartphone owned by the customer.

As an example, the information related to the entrance through which the customer has passed may be acquired from a camera installed in the store. Furthermore, a security camera installed in the store may be used.

As an example, the information related to the entrance through which the customer is estimated to have passed may be randomly determined from the plurality of entrances in the store. When the determination is made randomly, the determination may be made based on past information or the like acquired from the store such that an entrance having a high rate of passage of a plurality of customers has a high probability and an entrance having a low rate of passage of a plurality of customers has a low probability.

The information related to the entrance through which the customer is estimated to have passed may be estimated from the information related to the purchased product purchased by the customer. For example, an entrance positioned closest to a purchased product that is considered to have initially purchased by the customer may be used as the entrance through which the customer is estimated to have passed.

Note that the information related to the entrance through which the customer is estimated to have passed may not necessarily match the entrance through which the customer has actually passed.

As an example, the customer information master 221 illustrated in FIG. 6 is stored in the customer information storage unit 220.

The description returns to the description of FIG. 1. The control unit 300 is a functional unit that performs overall control of the information processing device 1.

The control unit 300 includes an acquisition unit 310, an estimation unit 320, a specification unit 330, and a calculation unit 340.

The acquisition unit 310 is a processing unit that acquires the store information and the customer information from an external device (not illustrated) or the like. The acquisition unit 310 stores the acquired store information in the store information storage unit 210, and stores the acquired customer information in the customer information storage unit 220.

The estimation unit 320 determines an estimation region in which each of a plurality of customers is estimated to have moved in the store based on the store information and the customer information.

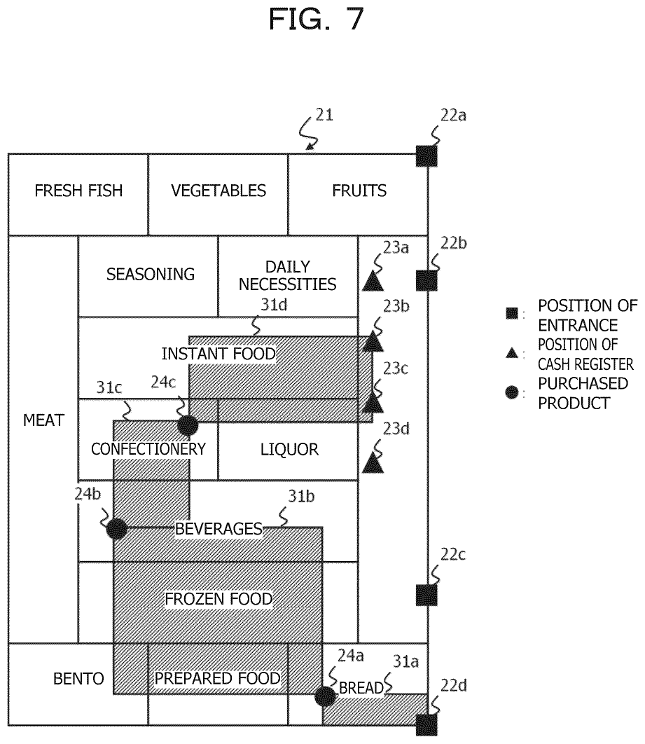

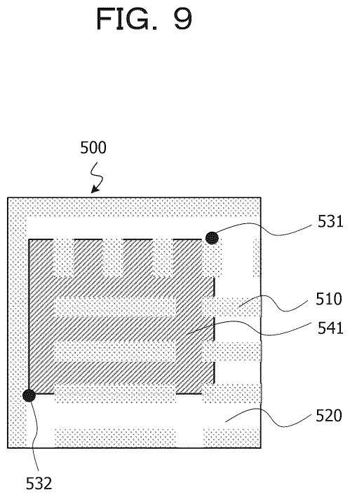

FIG. 7 is a diagram for describing an example of the estimation region estimated from the customer information. Note that a specific method of determining the estimation region will be described later (see FIGS. 9 to 12).

In FIG. 7, in addition to the store information illustrated in FIG. 2, a plurality of purchased products purchased by one customer and an estimation region in which the one customer is estimated to have moved are exemplified. In FIG. 7, the estimation region in which the one customer is estimated to have moved in a case where the one customer has entered the store from the fourth entrance 22d, has purchased the plurality of purchased products, and has made a payment for the plurality of purchased products at the second cash register 23b is exemplified.

The plurality of purchased products includes a first purchased product 24a, a second purchased product 24b, and a third purchased product 24c. In FIG. 7, as an example, it is assumed that the one customer has purchased the first purchased product 24a, the second purchased product 24b, and the third purchased product 24c in this order. Note that the purchase order in FIG. 7 may be purchase order actually acquired or purchase order estimated based on the store information and the customer information. The estimation region includes a first estimation region 31a, a second estimation region 31b, a third estimation region 31c, and a fourth estimation region 31d.

The first estimation region 31a is an example of an estimation region in which the one customer is estimated to have moved when the one customer has moved from the fourth entrance 22d to a position where the first purchased product 24a is arranged.

The second estimation region 31b is an example of an estimation region in which the one customer is estimated to have moved when the one customer has moved from the position where the first purchased product 24a is arranged to a position where the second purchased product 24b is arranged.

The third estimation region 31c is an example of an estimation region in which the one customer is estimated to have moved when the one customer has moved from the position where the second purchased product 24b is arranged to a position where the third purchased product 24c is arranged.

The fourth estimation region 31d is an example of an estimation region in which the one customer is estimated to have moved when the one customer has moved from the position where the third purchased product 24c is arranged to the second cash register 23b.

In this manner, the estimation unit 320 determines the estimation region in which the customer is estimated to have moved, including the first estimation region 31a, the second estimation region 31b, the third estimation region 31c, and the fourth estimation region 31d, based on the store information and the customer information.

Note that the estimation region illustrated in FIG. 7 includes the estimation region based on the information including the entrance where the customer has entered and the estimation region based on the information including the cash register at which the customer has made a payment, but may not include these. For example, the estimation region may include only the estimation region based on the information related to the product purchased by the customer. For example, taking FIG. 7 as an example, the estimation region in which the one customer is estimated to have moved may include only the second estimation region 31b and the third estimation region 31c.

For example, for each of a plurality of customers, the estimation unit 320 may determine the estimation region for a set of information specifying an (i−1)-th product purchased (i−1)-th and an i-th product purchased i-th by the customer, based on information related to an (i−1) total set and the store information. Here, i is a natural number equal to or larger than 2 and equal to or smaller than the number of products purchased by the customer.

A part of the estimation regions in FIG. 7 will be described as an example. The number of products purchased by the customer is three. The estimation unit 320 calculates the estimation region (second estimation region 31b) to be estimated from the first product (first purchased product 24a) and the second product (second purchased product 24b) in a case where i is 2. Furthermore, the estimation unit 320 calculates the estimation region (third estimation region 31c) to be estimated from the second product (second purchased product 24b) and the third product (third purchased product 24c) in a case where i is 3. The estimation unit 320 determines the estimation region by combining the second estimation region 31b and the third estimation region 31c.

Note that, in FIG. 7, the customer information with the customer ID “1” in the customer information master exemplified in FIG. 6 and the estimation region estimated from the customer information with the customer ID “1” are exemplified so as to correspond to each other.

For example, here, as an example, the entrance “4” indicated in FIG. 6 corresponds to the fourth entrance 22d indicated in FIG. 7. The cash register “2” indicated in FIG. 6 corresponds to the second cash register 23b indicated in FIG. 7.

Furthermore, as an example, the purchased product “loaf of bread” indicated in FIG. 6 corresponds to the first purchased product 24a indicated in FIG. 7. The purchased product “orange juice 500 ml” indicated in FIG. 6 corresponds to the second purchased product 24b indicated in FIG. 7. The purchased product “lightly salted potato chips” indicated in FIG. 6 corresponds to the third purchased product 24c indicated in FIG. 7.

Note that the product “loaf of bread” is included in a product category “bread”. The product “orange juice 500 ml” is included in a product category “beverages”. The product “lightly salted potato chips” is included in a product category “confectionery”.

The estimation unit 320 may determine the estimation region illustrated in FIG. 7 estimated from the one piece of customer information for the one customer. Note that, similarly to the estimation region illustrated in FIG. 7, the estimation unit 320 may determine an estimation region estimated from another piece of customer information for another customer. For example, in the customer information master 221 exemplified in FIG. 6, the estimation unit 320 may also estimate and determine estimation regions of the respective pieces of customer information with customer IDs “2”, “3”, and “4” from the customer information. Furthermore, the estimation unit 320 may determine the estimation region by adding the estimation regions of the respective plurality of customers.

Hereinafter, a comparison between a method of determining an estimation region in which a customer is estimated to have moved in the store and acquisition of a movement trajectory of the customer in the store in the prior art will be described.

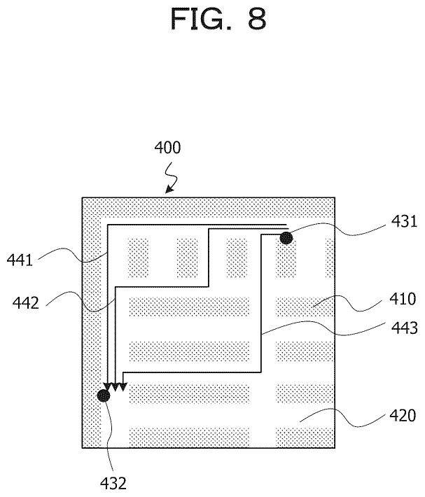

FIG. 8 is a diagram exemplifying a movement trajectory of a customer in the store. FIG. 8 is an example of a schematic diagram 400 in which a part of the inside of the store is viewed from above, and illustrates a plurality of product shelves 410 in which products are displayed and passages 420 among the plurality of product shelves 410. Note that, in FIG. 8, the plurality of product shelves 410 is indicated by a mesh, and the passages 420 are indicated in white inside the schematic diagram 400. Furthermore, in FIG. 8, a first purchased product 431 and a second purchased product 432 purchased by one customer are exemplified.

A case is assumed where the one customer moves through the passages 420 when moving from the product shelf 410 in which the first purchased product 431 is displayed to the product shelf 410 in which the second purchased product 432 is displayed. In FIG. 8, as an example only, three movement trajectories 441, 442, and 443 that are considered as movement trajectories in which the one customer passes through the passages 420 are exemplified.

Here, problems of the prior art will be described. As described above, there is a problem that it is difficult to accurately acquire a movement trajectory of a customer. Furthermore, there is also a problem that equipment becomes large in scale since it is needed to install, in a store, equipment for acquiring the movement trajectory of the customer.

Thus, in the information processing device 1 of the present embodiment, an estimation region in which a customer is estimated to have moved in the store is determined from information related to a purchased product of the customer without acquiring a movement trajectory of the customer. Note that, the estimation region in which the customer is estimated to have moved is, for example, a region where it may be estimated that there is a certain possibility or more that the customer has passed when the customer has moved.

FIG. 9 is a diagram illustrating a first specific example of an estimation region in which one customer is estimated to have moved. FIG. 9 is an example of a schematic diagram 500 in which a part of the inside of the store is viewed from above, and illustrates a plurality of product shelves 510 in which products are displayed and passages 520 among the plurality of product shelves 510. Note that, in FIG. 9, the plurality of product shelves 510 is indicated by a mesh, and the passages 520 are indicated in white inside the schematic diagram 500. As an example, the product shelves 510 are represented by rectangles. Furthermore, in FIG. 9, positions where a first purchased product 531 and a second purchased product 532 purchased by the one customer have been arranged are exemplified. As an example, information related to the product shelves 510 is stored in the store information storage unit 210, and information related to the positions where the first purchased product 531 and the second purchased product 532 have been arranged is stored in the customer information storage unit 220.

Furthermore, in FIG. 9, an estimation region 541 in which the one customer is estimated to have moved when the customer has moved from the product shelf 510 in which the first purchased product 531 is displayed to the product shelf 510 in which the second purchased product 532 is displayed is exemplified by a region indicated by diagonal lines. As an example, the estimation region 541 may be a region including a movement route that does not make a detour at the time of the movement from the product shelf 510 in which the first purchased product 531 is displayed to the product shelf 510 in which the second purchased product 532 is displayed. Furthermore, the estimation region 541 may have a rectangular shape. Moreover, the rectangular estimation region 541 may be determined with the positions where the first purchased product 531 and the second purchased product 532 have been arranged as vertexes. Note that the estimation region in which the customer is estimated to have moved is not limited to the estimation region 541 illustrated in FIG. 9.

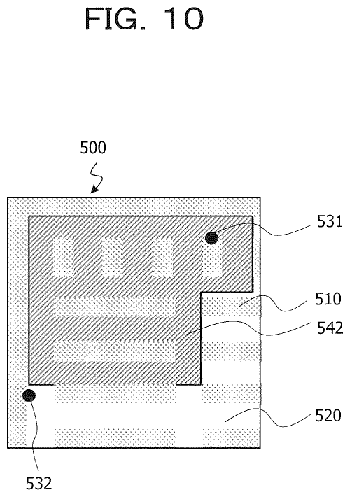

FIG. 10 is a diagram illustrating a second specific example of the estimation region in which the one customer is estimated to have moved. Similarly to FIG. 9, in FIG. 10, the schematic diagram 500, the plurality of product shelves 510, the plurality of passages 520, the positions where the first purchased product 531 and the second purchased product 532 have been arranged are exemplified.

In FIG. 10, an estimation region 542 in which the one customer is estimated to have moved when the customer has moved from the product shelf 510 in which the first purchased product 531 is displayed to the product shelf 510 in which the second purchased product 532 is displayed is exemplified by a region indicated by diagonal lines. The estimation region 542 illustrated in FIG. 10 is different from the estimation region 541 illustrated in FIG. 9.

The estimation region 542 may be extended from the estimation region 541. For example, the region may be determined such that a passage adjacent to the first purchased product 531 is included in addition to the estimation region 541. The estimation region 542 may be a region including a movement route that makes a detour. Furthermore, the estimation region 542 may have a polygonal shape. Moreover, the polygonal estimation region 542 does not have be determined with the first purchased product 531 and the second purchased product 532 as vertexes.

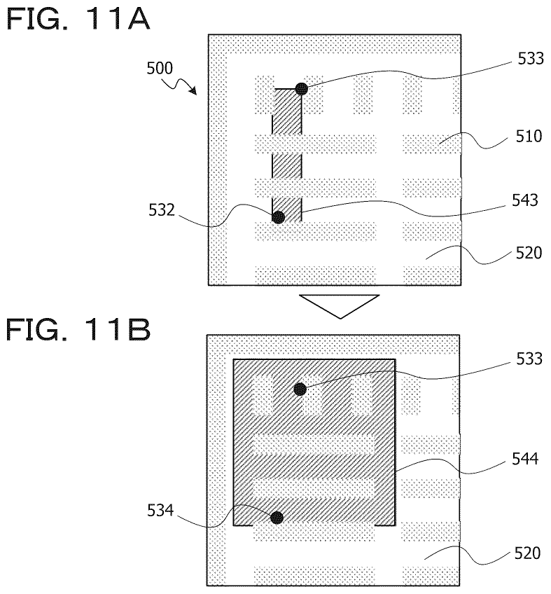

FIGS. 11A and 11B are diagrams illustrating a third specific example of the estimation region in which the one customer is estimated to have moved. Similarly to FIG. 9, in FIGS. 11A and 11B, the schematic diagram 500, the plurality of product shelves 510, and the plurality of passages 520 are exemplified. Furthermore, in FIGS. 11A and 11B, positions where a first purchased product 533 and a second purchased product 534 purchased by the one customer have been arranged, which are different from those in FIG. 9, are exemplified.

In FIG. 11A, an estimation region 543 in which the one customer is estimated to have moved when the customer has moved from the product shelf 510 in which the first purchased product 533 is displayed to the product shelf 510 in which the second purchased product 534 is displayed is exemplified by a region indicated by diagonal lines.

At least one or more sides of a plurality of sides of the estimation region 543 illustrated in FIG. 11A overlap the product shelves 510. In this case, the estimation region 543 may be changed such that one or a plurality of sides of the estimation region 543 does not overlap the product shelves 510. In FIG. 11B, as an example, an estimation region 544 after extending the estimation region 543 is exemplified.

A plurality of sides of the estimation region 544 illustrated in FIG. 11B does not overlap the product shelves 510. Note that the estimation region 543 may be changed such that all the sides of the plurality of sides of the estimation region 544 do not overlap the product shelves 510, or the estimation region 543 may be changed such that at least one or more sides do not overlap the product shelves 510. The change of the estimation region 543 may include reduction of the region.

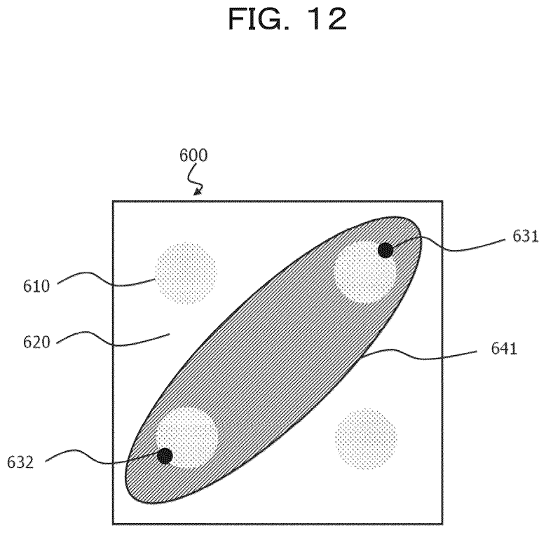

FIG. 12 is a diagram illustrating a fourth specific example of the estimation region in which the one customer is estimated to have moved. FIG. 12 is an example of a schematic diagram 600 in which a part of the inside of the store is viewed from above, and illustrates a plurality of product shelves 610 in which products are displayed and passages 620 among the plurality of product shelves 610. As an example, the product shelves 610 are represented by circles. Furthermore, in FIG. 12, positions where a first purchased product 631 and a second purchased product 632 purchased by the one customer have been arranged are exemplified. As an example, information related to the product shelves 610 is stored in the store information storage unit 210, and information related to the positions where the first purchased product 631 and the second purchased product 632 have been arranged is stored in the customer information storage unit 220.

In FIG. 12, an estimation region 641 in which the one customer is estimated to have moved when the customer has moved from the product shelf 610 in which the first purchased product 631 is displayed to the product shelf 610 in which the second purchased product 632 is displayed is exemplified by a region indicated by diagonal lines. The estimation region 641 illustrated in FIG. 12 is different from the estimation region 541 illustrated in FIG. 9, and does not have to have a polygonal shape. For example, the estimation region 641 may have an elliptical shape, or may have an optional shape as long as it represents an estimation region through which the customer is estimated to have possibly passed.

The description returns to the description of FIG. 1. The specification unit 330 specifies specification information included in an estimation region determined by the estimation unit 320 in the store information. The specification information is information related to a product included in the estimation region. The information related to the product may be information related to the product or information related to a product category. Furthermore, the specification information may be information related to a product category excluding a product category of a purchased product purchased by a customer. Therefore, it is possible to evaluate whether a product other than the product category of the purchased product that has been purchased has product visibility to the customer.

An example of the specification information will be described with reference to FIG. 7. Here, the description will be given assuming that the specification information is information related to product categories excluding product categories of the purchased products purchased by the customer.

The product category included in the first estimation region 31a is “bread”. The product categories included in the second estimation region 31b are “bread”, “prepared food”, “bento”, “frozen food”, and “beverages”. The product categories included in the third estimation region 31c are “beverages” and “confectionery”. The product categories included in the fourth estimation region 31d are “confectionery”, “liquor”, and “instant food”.

On the other hand, the product category of the first purchased product 24a purchased by the one customer is “bread”, the product category of the second purchased product 24b is “beverages”, and the product category of the third purchased product 24c is “confectionery”.

In this case, the specification unit 330 specifies specification information indicating “prepared food”, “bento”, “frozen food”, “liquor”, and “instant food” which are the product categories excluding the product categories of the purchased products.

Note that the specification information may be similarly specified not only for the one customer but also for each of a plurality of other customers. Furthermore, the specification information may include the specification information related to the one customer and the specification information related to the plurality of other customers.

The description returns to the description of FIG. 1. The calculation unit 340 calculates an evaluation value for evaluating how much a product is considered to have come into sight of a plurality of customers based on the store information and an estimation region. For example, the calculation unit 340 estimates that a product that has entered an estimation region for one customer may have come into sight of the one customer. Similarly, the calculation unit 340 estimates that a product that has entered an estimation region for another customer may have come into sight of the another customer. The calculation unit 340 similarly performs estimation for a plurality of customers, and calculates an evaluation value.

The calculation unit 340 may calculate the evaluation value assuming that a degree of coming into sight of the one customer is the same for all products arranged in the estimation region of the one customer. Furthermore, the calculation unit 340 may calculate a total of the evaluation values assuming that a degree of coming into sight of each of a plurality of customers is the same for all products arranged in an estimation region of each of the plurality of customers. On the other hand, the calculation unit 340 may set weighting in each estimation region such that a degree to which a product comes into sight of a customer is different in the estimation region, and calculate the evaluation value. For example, the weighting may be set in the estimation region according to a distance from coordinates of a product purchased by a customer.

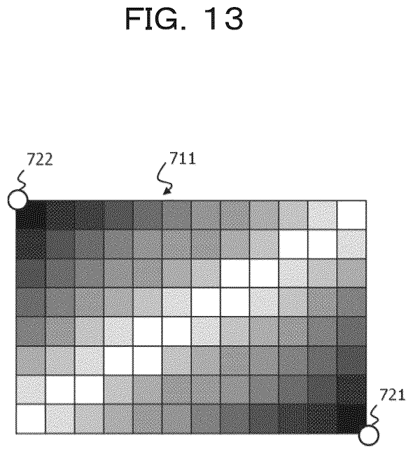

FIG. 13 is a diagram for describing a first specific example of the weighting. In FIG. 13, positions where a first purchased product 721 and a second purchased product 722 purchased by one customer have been arranged are exemplified. Furthermore, an example of weighting of an estimation region 711 in which the one customer is estimated to have moved when the customer has moved from the position where the first purchased product 721 has been arranged to the position where the second purchased product 722 has been arranged is expressed. In the estimation region 711, the larger a weight, the darker a color expressed, and the smaller the weight, the lighter the color expressed.

As illustrated in FIG. 13, the weighting may be set in the estimation region 711 such that the weight increases as coordinates of the product purchased by the customer are approached. In FIG. 13, the weight is set stepwise for each region obtained by vertically dividing the estimation region 711 into eight and horizontally dividing the estimation region 711 into 12, but the weight may be continuously set without dividing the region. The calculation unit 340 calculates the evaluation value such that a degree to which the product has come into sight of the customer becomes higher as the weight is set to be larger.

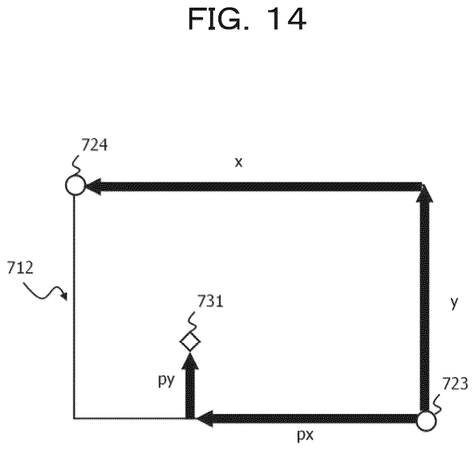

FIG. 14 is a diagram for describing an example of a weighting calculation method. In FIG. 14, positions where a first purchased product 723 and a second purchased product 724 purchased by one customer have been arranged are exemplified. Furthermore, an estimation region 712 in which the one customer is estimated to have moved when the customer has moved from the position where the first purchased product 723 has been arranged to the position where the second purchased product 724 has been arranged is exemplified. In FIG. 14, the estimation region 712 is exemplified by a rectangle.

As an example, the estimation region 712 is a rectangular region in which the position where the first purchased product 723 has been arranged is set as lower right coordinates and the position where the second purchased product 724 has been arranged is set as upper left coordinates. As an example, the estimation region 712 is the rectangular region having, as sides, a straight line extended upward by y and a straight line extended leftward by x from the position where the first purchased product 723 has been arranged. Here, the leftward is defined as an x direction, and the upward is defined as a y direction. Note that, as an example, x is a value obtained by subtracting an x coordinate of the first purchased product 723 from an x coordinate of the second purchased product 724. Furthermore, as an example, y is a value obtained by subtracting a y coordinate of the first purchased product 723 from a y coordinate of the second purchased product 724.

Here, when a position where a product 731 arranged in the store is arranged is defined as px in the x direction from the x coordinate of the first purchased product 723 and py in the y direction from the y coordinate of the first purchased product 723, a weighting evaluation value is calculated by Expression (1), as an example.

$$Weighting evaluation value = \frac{1}{2} {( \frac{px}{x} + \frac{py}{y} - 1 )}^{2} + \frac{1}{2} \qquad ( 1 )$$

The weighting evaluation value is not limited to Expression (1). For example, an optional weighting evaluation value may be used as long as a weight may be set so as to increase as coordinates of a product purchased by the customer are approached.

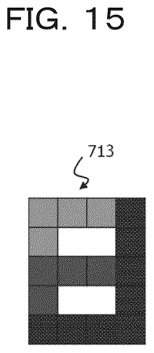

FIG. 15 is a diagram for describing a second specific example of the weighting. In FIG. 15, an example in which weighting is set to an estimation region 713 in which a customer is estimated to have moved using data related to the customer is expressed.

For example, in the estimation region 713, the calculation unit 340 performs setting based on past data, such that a weight increases as a frequency at which the customer has passed increases. As an example, the frequency at which the customer has passed may be calculated based on imaged data imaged by a camera or the like installed in the store. Furthermore, in setting the weight, the calculation unit 340 does not need to detect an operation of passing by the customer, and may set the weight to increase as a time during which the customer has been present becomes longer, from the time during which the customer has been present in each certain section.

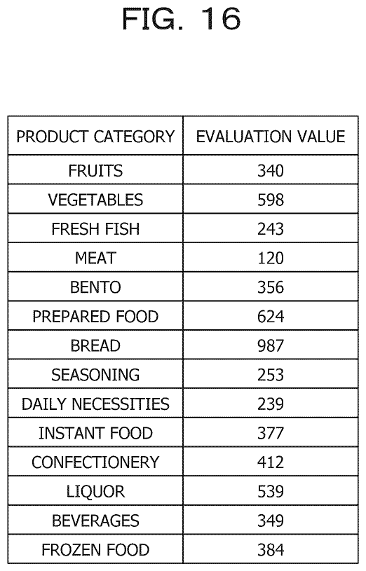

FIG. 16 is a diagram for describing a specific example of an evaluation value for evaluating how much a product is considered to have come into sight of a plurality of customers. In FIG. 16, the evaluation value calculated by the calculation unit 340 is exemplified for each product category. The product category “meat” has the lowest evaluation value of “120” and the product category “bread” has the highest evaluation value of “987”. For example, it is estimated that the product category “meat” frequently comes into sight of the customers, and the product category “bread” less comes into sight of the customers.

By referring to the evaluation values indicated in FIG. 16, the calculation unit 340 may evaluate how much a product is considered to have come into sight of the plurality of customers based on the store information and the customer information acquired by the acquisition unit 310.

Note that the acquisition unit 310 newly acquires store information assuming a layout change, and a user may know a change in the evaluation value calculated by the calculation unit 340 based on the same customer information as the customer information acquired before the layout change and the store information assuming the layout change.

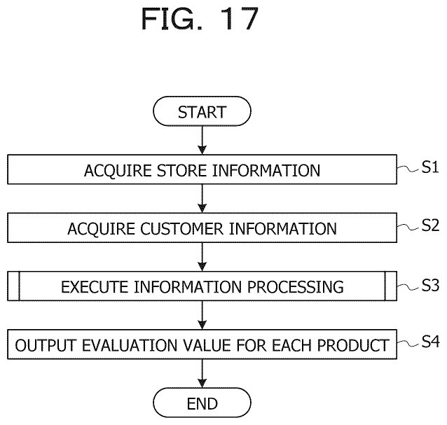

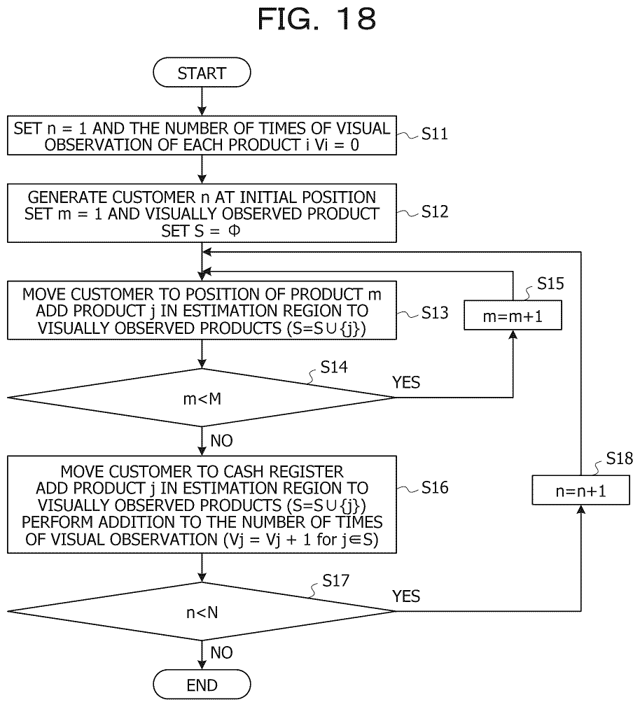

FIG. 17 is a flowchart illustrating an example of a procedure of the processing of the information processing device 1 according to the present embodiment. As illustrated in FIG. 17, the acquisition unit 310 acquires the store information (step S1). Subsequently, the acquisition unit 310 acquires the customer information (step S2). Then, the estimation unit 320, the specification unit 330, and the calculation unit 340 execute information processing (step S3). Details of the information processing will be described later (see FIG. 18). Finally, the output unit 130 outputs a calculation result of an evaluation value for evaluating how much a product is considered to have come into sight of a plurality of customers (step S4).

FIG. 18 is a flowchart illustrating an example of the details of the information processing. As illustrated in FIG. 18, the estimation unit 320 sets n=1 for a natural number n for identifying a customer. Furthermore, the estimation unit 320 sets a natural number for identifying each product as i and the number of times of visual observation of each product i Vi=0, and performs initialization (step S11). Note that each product may be each product category. Furthermore, the number of times of visual observation Vi may be an evaluation value for evaluating how much a product is considered to have come into sight of a plurality of customers.

Subsequently, the estimation unit 320 arranges the customer n in simulation at an initial position where the customer n has been initially present or is estimated to have been initially present in the store. The initial position is, for example, an entrance through which the customer has passed or is estimated to have passed. The initial position may be a position of a purchased product that the customer has initially purchased or is estimated to have initially purchased. Furthermore, the estimation unit 320 sets m=1 for a natural number m for identifying the product purchased by the customer. Additionally, the estimation unit 320 sets a visually observed product set S=Φ (Φ is an empty set), and performs initialization (step S12). Here, the visually observed product set S is a set of products considered to have come into sight of the customer.

Next, the estimation unit 320 moves the customer to a position of the product m, and adds a product j in an estimation region in which the customer is estimated to have moved to visually observed products (S=S∪{j}) (step S13).

Then, the number of products purchased by the customer n is set as M, and in the case of m<M (Yes in step S14), the estimation unit 320 sets m=m+1. For example, the estimation unit 320 adds 1 to m (step S15), and executes the processing of step S13.

On the other hand, in the case of not m<M (No in step S14), the estimation unit 320 moves the customer to a cash register, and adds the product j in the estimation region in which the customer is estimated to have moved to the visually observed products (S=S∪{j}). Furthermore, the estimation unit 320 performs addition to the number of times of visual observation Vi (Vi=Vi+1 for j∈S) (step S16). Here, 1 is added to the number of times of visual observation Vi. However, for example, in a case where weighting is performed in the estimation region as illustrated in FIG. 13, a value to be added may be changed depending on a position in the estimation region.

Then, the total number of customers is set as N, and in the case of n<N (Yes in step S17), the estimation unit 320 sets n=n+1. For example, the estimation unit 320 adds 1 to n (step S18), and executes the processing of step S13.

On the other hand, in the case of not n<N (No in step S17), the estimation unit 320 ends the processing.

Here, effects obtained by the information processing described above will be described.

In the present embodiment, the information processing device 1 determines an estimation region in which each of a plurality of customers is estimated to have moved in a store based on information related to arrangement of a plurality of products in the store and information specifying one or a plurality of products purchased by each of the plurality of customers. For example, the information processing device 1 determines the estimation region in which each of the plurality of customers is estimated to have moved without needing equipment or a technology for acquiring a movement trajectory of the customer. Therefore, for example, a user may easily evaluate how much a product has come into sight of the customers using the information processing device 1.

Furthermore, the user may also easily consider a layout change in the store.

For example, the information processing device 1 acquires store information related to a current store layout and customer information in the current store layout. Thereafter, the information processing device 1 determines an estimation region in which a customer is estimated to have moved, and calculates a first evaluation value for evaluating how much a product has come into sight of the customer.

Next, the information processing device 1 acquires store information related to a temporary store layout considered as a change destination and the customer information in the current store layout. Thereafter, the information processing device 1 determines an estimation region in which the customer is estimated to have moved, and calculates a second evaluation value for evaluating how much the product has come into sight of the customer.

The user compares the first evaluation value with the second evaluation value, and for example, in a case where the second evaluation value is higher between the evaluation values of the product that is desired to come into sight of the customer more, the user may easily understand that the temporary store layout considered as the change destination is better.

In this manner, the user may easily grasp a difference in evaluation of how much a product comes into sight for each layout of the store using the information processing device 1 without a layout change in the actual store.

In the present embodiment, the information processing device 1 may also consider, for each of the plurality of customers, purchase order of a plurality of products purchased by the customer. Note that the purchase order may be estimated based on at least one of entrances or cash registers of the store used by the customer. Therefore, the information processing device 1 may improve accuracy of determination of the estimation region in which each customer is estimated to have moved.

In the present embodiment, for each of the plurality of customers, the information processing device 1 may determine the estimation region for a set of information specifying the (i−1)-th product purchased (i−1)-th and the i-th product purchased i-th by the customer, based on information related to an (i−1) total set and the store information. Here, i is a natural number equal to or larger than 2 and equal to or smaller than the number of products purchased by the customer. Therefore, the information processing device 1 may improve accuracy of determination of the estimation region in which each customer is estimated to have moved.

In the present embodiment, the information processing device 1 may easily determine the estimation region by setting, as the estimation region, a rectangular region having at least one of coordinates of a product purchased by the customer as a vertex.

In the present embodiment, the information processing device 1 may set the estimation region to include at least one route that allows movement from coordinates of one product purchased by the customer to coordinates of another product purchased by the customer. Therefore, the information processing device 1 may improve the accuracy of the determination of the estimation region in which each customer is estimated to have moved.

In the present embodiment, the information processing device 1 may set weighting to the estimation region, and evaluate how much a product has come into sight of the customer based on the estimation region to which the weighting is set. For example, the information processing device 1 may also perform the setting such that the weighting increases as coordinates of the product purchased by the customer are approached in the estimation region. Therefore, the information processing device 1 may improve accuracy of the evaluation.

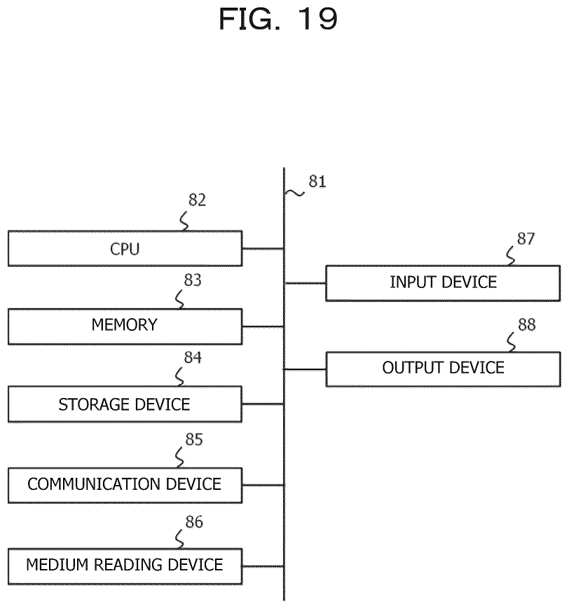

FIG. 19 is a diagram illustrating an example of a hardware configuration of the information processing device 1 according to the present embodiment. The information processing device 1 is, for example, an information processing device including a central processing unit (CPU) 82, a memory 83, a storage device 84, a communication device 85, a medium reading device 86, an input device 87, and an output device 88, which are coupled to each other by a bus 81.

The CPU 82 performs various types of operation control in the information processing device 1. The CPU 82 may read a program stored in the memory 83 or the storage device 84 and execute processing and control, thereby implementing the control unit 300 and each functional unit included in the control unit 300 illustrated in FIG. 1. Note that the control unit 300 may be implemented by a hardware processor such as a micro processing unit (MPU) in addition to the CPU. Here, while the CPU and the MPU are exemplified as an example of the processor, the control unit 300 may be implemented by an optional processor regardless of whether it is a versatile type or a dedicated type. Additionally, the control unit 300 may also be implemented by a hard wired logic such as an application specific integrated circuit (ASIC) or a field programmable gate array (FPGA).

The memory 83 and the storage device 84 store programs that execute various types of processing described in the present embodiment and various types of data used for the various types of processing. The memory 83 is, for example, a semiconductor memory element such as a random access memory (RAM) or a flash memory. The storage device 84 is, for example, a storage medium such as a hard disk drive (HDD) or a solid state drive (SSD). Furthermore, each of the memory 83 and the storage device 84 may function as the storage unit 200 illustrated in FIG. 1.

The communication device 85 is hardware used for transmission and reception of data via a wired or wireless network. The communication device 85 is, for example, a network interface card (NIC) or the like. The communication device 85 may function as the communication unit 110 illustrated in FIG. 1 under the control of the CPU 82.

The medium reading device 86 is a device for reading data from a recording medium. The medium reading device 86 is, for example, a disk drive that reads data stored in a disk medium such as a compact disc read only memory (CD-ROM) or a digital versatile disc read only memory (DVD-ROM), a card slot that reads data stored in a memory card, or the like. It may be assumed that part or all of data stored in the storage unit 200 described above is stored in a recording medium readable using the medium reading device 86.

The input device 87 is a device that receives an input and specification from a user of the information processing device 1. The input device 87 is, for example, a keyboard, a mouse, a touch pad, or the like. The input device may function as the input unit 120 illustrated in FIG. 1.

The output device 88 is a device that displays information output from the control unit 300 under the control of the CPU 82. The output device 88 is, for example, a touch panel, a liquid crystal display, an organic electro-luminescence (EL) display, or the like. The output device may function as the output unit 130 illustrated in FIG. 1.

While the disclosed embodiment and the advantages thereof have been described in detail, those skilled in the art will be able to make various modifications, additions, and omissions without departing from the scope of the present disclosure as explicitly set forth in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information processing program for causing a computer to execute processing comprising:
acquiring first information that includes information related to arrangement of a plurality of products in a store;
acquiring second information that includes information that specifies one or a plurality of the products purchased by each of a plurality of customers;
determining an estimation region in which each of the plurality of customers is estimated to have moved in the store based on the first information and the second information; and
calculating an evaluation value for evaluation of how much the product is considered to have come into sight of the plurality of customers based on the first information and the estimation region.

2. The non-transitory computer-readable recording medium according to claim 1, wherein
the first information further includes information related to arrangement of one or a plurality of cash registers in the store or information related to arrangement of one or a plurality of entrances in the store or a combination of both the pieces of information,
the second information further includes information related to a cash register used by each of the plurality of customers among the cash registers or information related to an entrance through which each of the plurality of customers has passed or is estimated to have passed among the entrances or a combination of both the pieces of information, and
the computer is caused to further execute processing including:
estimating, for each of the plurality of customers, purchase order of a plurality of the products purchased by the customer based on the first information and the second information; and
determining the estimation region based on the first information, the second information, and the estimated purchase order.

3. The non-transitory computer-readable recording medium according to claim 1, for causing the computer to further execute processing comprising:
acquiring, for each of the plurality of customers, purchase order of a plurality of the products purchased by the customer; and
determining the estimation region based on the first information, the second information, and the acquired purchase order.

4. The non-transitory computer-readable recording medium according to claim 2, for causing the computer to further execute processing comprising
determining, for each of the plurality of customers, the estimation region for a set of information that specifies an (i−1)-th product (i is a natural number equal to or larger than 2 and equal to or smaller than the number of products purchased by the customer) purchased (i−1)-th by the customer and information that specifies an i-th product purchased i-th by the customer among a plurality of the products purchased by the customer, based on information related to an (i−1) total set and the first information.

5. The non-transitory computer-readable recording medium according to claim 1, wherein
the estimation region is a rectangular region that has one or more coordinates of the product purchased by the customer as a vertex.

6. The non-transitory computer-readable recording medium according to claim 1, wherein
the estimation region is a region that includes one or more routes that allows movement from coordinates of one product purchased by the customer to coordinates of another product purchased by the customer.

7. The non-transitory computer-readable recording medium according to claim 1, for causing the computer to further execute processing comprising:
setting weighting to the estimation region according to a distance from coordinates of the product purchased by the customer; and
calculating the evaluation value based on the estimation region to which the weighting is set.

8. The non-transitory computer-readable recording medium according to claim 1, for causing the computer to further execute processing comprising:
setting weighting to the estimation region such that the weighting increases as coordinates of the product purchased by the customer are approached; and
calculating the evaluation value based on the estimation region to which the weighting is set.

9. An information processing method, implemented by a computer, the information processing method comprising:
acquiring first information that includes information related to arrangement of a plurality of products in a store;
acquiring second information that includes information that specifies one or a plurality of the products purchased by each of a plurality of customers;
determining an estimation region in which each of the plurality of customers is estimated to have moved in the store based on the first information and the second information; and
calculating an evaluation value for evaluation of how much the product is considered to have come into sight of the plurality of customers based on the first information and the estimation region.

10. The information processing method according to claim 9, wherein
the first information further includes information related to arrangement of one or a plurality of cash registers in the store or information related to arrangement of one or a plurality of entrances in the store or a combination of both the pieces of information,
the second information further includes information related to a cash register used by each of the plurality of customers among the cash registers or information related to an entrance through which each of the plurality of customers has passed or is estimated to have passed among the entrances or a combination of both the pieces of information, and
the computer is caused to further execute processing including:
estimating, for each of the plurality of customers, purchase order of a plurality of the products purchased by the customer based on the first information and the second information; and
determining the estimation region based on the first information, the second information, and the estimated purchase order.

11. The information processing method according to claim 9, for causing the computer to further execute processing comprising:
acquiring, for each of the plurality of customers, purchase order of a plurality of the products purchased by the customer; and
determining the estimation region based on the first information, the second information, and the acquired purchase order.

12. The information processing method according to claim 10, for causing the computer to further execute processing comprising
determining, for each of the plurality of customers, the estimation region for a set of information that specifies an (i−1)-th product (i is a natural number equal to or larger than 2 and equal to or smaller than the number of products purchased by the customer) purchased (i−1)-th by the customer and information that specifies an i-th product purchased i-th by the customer among a plurality of the products purchased by the customer, based on information related to an (i−1) total set and the first information.

13. The information processing method according to claim 9, wherein
the estimation region is a rectangular region that has one or more coordinates of the product purchased by the customer as a vertex.

14. The information processing method according to claim 9, wherein
the estimation region is a region that includes one or more routes that allows movement from coordinates of one product purchased by the customer to coordinates of another product purchased by the customer.

15. The information processing method according to claim 9, for causing the computer to further execute processing comprising:
setting weighting to the estimation region according to a distance from coordinates of the product purchased by the customer; and
calculating the evaluation value based on the estimation region to which the weighting is set.

16. The information processing method according to claim 9, for causing the computer to further execute processing comprising:
setting weighting to the estimation region such that the weighting increases as coordinates of the product purchased by the customer are approached; and
calculating the evaluation value based on the estimation region to which the weighting is set.

17. An information processing device comprising:
a memory;
a processor coupled with the memory and configured to
acquire first information that includes information related to arrangement of a plurality of products in a store and second information that includes information that specifies one or a plurality of the products purchased by each of a plurality of customers;
determine an estimation region in which each of the plurality of customers is estimated to have moved in the store based on the first information and the second information; and
calculate an evaluation value for evaluation of how much the product is considered to have come into sight of the plurality of customers based on the first information and the estimation region.

18. The information processing device according to claim 17, wherein
the first information further includes information related to arrangement of one or a plurality of cash registers in the store or information related to arrangement of one or a plurality of entrances in the store or a combination of both the pieces of information,
the second information further includes information related to a cash register used by each of the plurality of customers among the cash registers or information related to an entrance through which each of the plurality of customers has passed or is estimated to have passed among the entrances or a combination of both the pieces of information,
the processor estimates, for each of the plurality of customers, purchase order of a plurality of the products purchased by the customer based on the first information and the second information, and determines the estimation region based on the first information, the second information, and the estimated purchase order.

19. The information processing device according to claim 17, wherein
the processor acquires, for each of the plurality of customers, purchase order of a plurality of the products purchased by the customer, and determines the estimation region based on the first information, the second information, and the acquired purchase order.

20. The information processing device according to claim 18, wherein
the processor determines, for each of the plurality of customers, the estimation region for a set of information that specifies an (i−1)-th product (i is a natural number equal to or larger than 2 and equal to or smaller than the number of products purchased by the customer) purchased (i−1)-th by the customer and information that specifies an i-th product purchased i-th by the customer among a plurality of the products purchased by the customer, based on information related to an (i−1) total set and the first information.
